(19) United States
(12) Patent Application Publication
(10) Pub. No.: US 2009/0086823 A1
(43) Pub. Date: Apr. 2, 2009

(54) Apparatus and Method for Decoding Multimedia Content According to a Control Signal and System Comprising the Same

(75) Inventor: Kung-Sheng Lin, Hsinchu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 11/863,691

(22) Filed: Sep. 28, 2007

(51) Int. Cl. H04N 7/24

(52) U.S. Cl. 375/240.24; 375/E07.017

(57) ABSTRACT

A system, an apparatus and a method for decoding a multimedia content according to a control signal are provided. The apparatus comprises a memory and a decoder. The memory stores the multimedia content. The apparatus decodes the multimedia content. The control signal determines a number so that the decoder decodes the multimedia content to the number of macroblocks. The control signal is determined in response to a bandwidth status and/or a buffer status.

### CROSS-REFERENCES TO RELATED APPLICATIONS

This application is co-pending with the application entitled “VIDEO DECODING APPARATUS AND SYSTEMS” filed on the same date by the same inventor of this invention.

### BACKGROUND OF THE INVENTION

1. Field of the Invention

The present invention relates to a system, an apparatus, and a method for decoding multimedia content. More particularly, the present invention relates to a system, an apparatus, and a method for decoding multimedia content according to a control signal.

2. Descriptions of the Related Art

Multimedia data playback systems are commonly used around the world to decode multimedia content into video presentations. Since a macroblock is a type of basic decoding unit, a conventional decoding system is required to set a specific number of macroblocks before decoding. The conventional decoding system then decodes the multimedia content to that specific number of macroblocks. To be more specific, since current video standards group different number of macroblocks into a macroblock row, a slice, or a picture, a conventional decoding system may decode the multimedia content to a slice, a macroblock row, or a picture by setting the specific number. However, conventional decoding systems of multimedia data playback systems usually set the specific number to be a fixed number. Therefore, the conventional system can only decode the multimedia content to the fixed number of macroblocks. Consequently, the decoding capability of conventional decoding systems is limited and can not be modulated in response to different requirements.

Thus, a decoding system with adjustable decoding capability to modulate the number of macroblocks is desired, fulfilling different decoding requirements.

### SUMMARY OF THE INVENTION

The primary objective of this invention is to provide an apparatus for decoding multimedia content according to a control signal. The control signal determines a number, from which the decoder decodes the multimedia content according to that number of macroblocks.

To achieve the objective, the control signal can either be manually determined by a user or be set according to a buffer status and/or a bandwidth status, both of which represent the process status of the decoding apparatus.

Another objective of this invention is to provide an apparatus for decoding multimedia content according to a control signal. The apparatus comprises a memory and a decoder. The memory is configured to store a part of the multimedia content, wherein the part of the multimedia content comprises at least one encoded macroblock. The decoder is configured to decode a portion of the part of the multimedia content to a first number of at least one macroblock, wherein the first number is determined by the control signal. The part of the multimedia content is retrieved from a bitstream and the bitstream is related to one of an image and a video content.

Another objective of this invention is to provide an apparatus for decoding multimedia content according to a control signal. The apparatus comprises storing means for storing a part of the multimedia content and decoding means for decoding a portion of the part of the multimedia content to a first number of at least one macroblock. The part of the multimedia content comprises at least one encoded macroblock. The first number is determined by the control signal. The part of the multimedia content is retrieved from a bitstream, wherein the bitstream is related to one of an image and a video content.

Another objective of this invention is to provide a method for decoding multimedia content according to a control signal. The method can be executed using the aforementioned apparatus for decoding. The control signal here is determined in the same way as mentioned above.

A further objective of this invention is to provide a method for decoding multimedia content according to a control signal. The method comprises the steps of storing a part of the multimedia content and decoding a portion of the part of the multimedia content to a first number of at least one macroblock. The part of the multimedia content comprises at least one encoded macroblock. The first number is determined by the control signal. The part of the multimedia content is retrieved from a bitstream and the bitstream is related to one of an image and a video content.

Yet a further objective of this invention is to provide a system. The system may be a multimedia system, a television, a portable multimedia playback system, a DVD system, or something alike. The system comprises a receiver and an apparatus. The receiver is configured to receive multimedia content and a control signal. The apparatus is configured to decode the multimedia content according to the control signal. The apparatus comprises a memory and a decoder. The memory is configured to store a part of the multimedia content, wherein the part of the multimedia content comprises at least one encoded macroblock. The decoder is configured to decode a portion of the part of the multimedia content to a first number of at least one macroblock, wherein the first number is determined by the control signal. The part of the multimedia content is retrieved from a bitstream and the bitstream is related to one of image and video content.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a concept of the hierarchical structure of a video bitstream;

FIG. 2 is the preferred embodiment of a decoding sub-system of the invention; and

FIG. 3 is a flowchart of a mehotd for decoding multimedia content according to an embodiment of the invention.

### DESCRIPTION OF THE PREFERRED EMBODIMENT

In the descriptions that follow, the present invention will be described in reference to embodiments that decode multimedia content according to a control signal. However, embodiments of the invention are not limited to any particular environment, application or implementation. Therefore, the descriptions of the embodiments that follow are for illustration and not limitation.

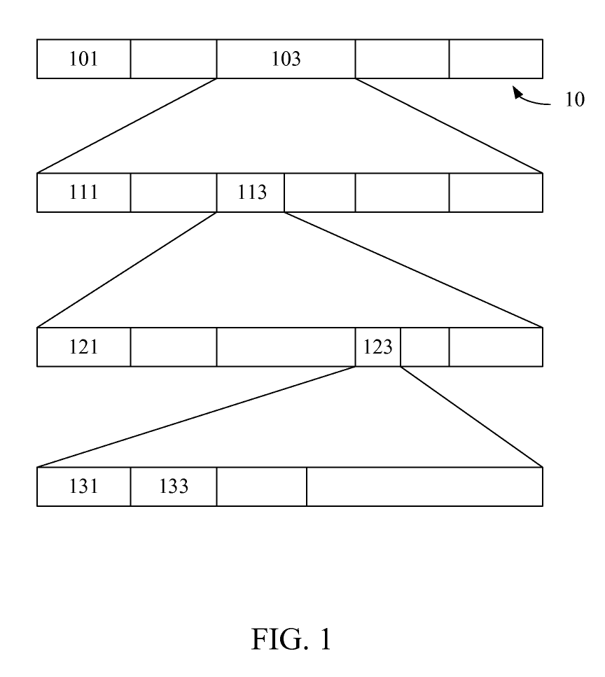

FIG. 1 illustrates the concept of the hierarchical structure of a bitstream comprising multimedia content. The multimedia content is retrieved from the bitstream related to one of image and video content. Particularly, the multimedia content is Joint Photographic Experts Group (JPEG) or Moving Picture Experts Group (MPEG) bitstreams. The bitstream comprises the following layers: video sequence, group of pictures (GOP), picture, slice, and macroblock. Each former layer comprises the latter with a header. For example, as shown in FIG. 1, a video sequence 10 comprises a video sequence header 101 and at least one GOP 103. Similarly, the GOP 103 comprises a GOP header 111 and at least one picture 113. The picture 113 comprises a picture header 121 and at least one slice 123. Likewise, the slice 123 comprises a slice header 131 and at least one macroblock 133. A macroblock row comprises a plurality of macroblocks. According to Moving Picture Experts Group-2 (MPEG-2) video standard, a single slice comprises multiple macroblocks within a single macroblock row. The macroblock is the basis of the video bitstream, i.e. a number of macroblocks forms at least one of a macroblock row, a slice, and a picture of the multimedia content.

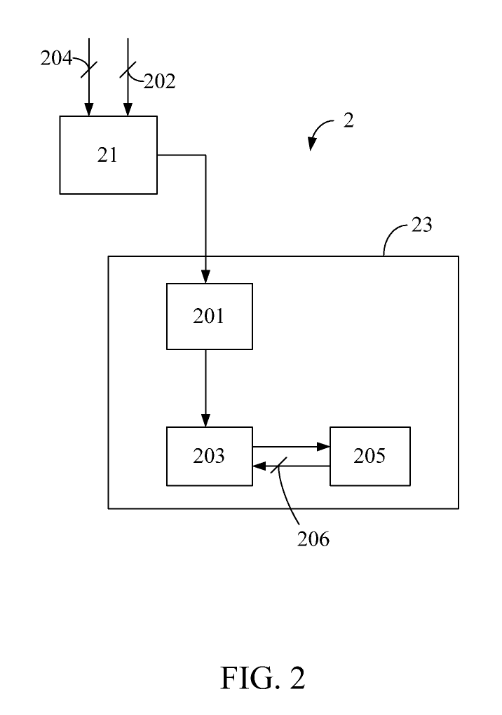

FIG. 2 illustrates a preferred embodiment of a sub-system 2 that can be used to decode a multimedia content. The sub-system 2 can be applied to many kinds of systems, such as multimedia systems, televisions, portable multimedia playback systems, or DVD systems. The sub-system 2 comprises a receiver 21 and an apparatus 23, in which the receiver 21 receives a control signal 202 and multimedia content 204. The apparatus 23 is configured to decode the multimedia content 204 according to the control signal 202. The control signal 202 can be determined either manually or according to any of a buffer status and/or a bandwidth status. The buffer status represents the ability of the sub-system 2 for buffering decoded multimedia content. Meanwhile, the bandwidth status represents the ability of the sub-system 2 for processing the decoded multimedia content simultaneously. When the buffer status and bandwidth status indicate the system can buffer or process more decoded multimedia content, the control signal 202 is then determined to allow the sub-system 2 to decode more multimedia content.

The apparatus 23 comprises a memory 201, a decoder 203, and a counter 205. The memory 201 is configured to store a part of the multimedia content 204. According to the aforementioned descriptions of the video bitstream, it is known that part of the multimedia content 204 comprises at least one encoded macroblock. The decoder 203 is configured to decode a portion of the part of the multimedia content 204 to a first number of macroblocks. The first number is determined by the control signal 202 and is equal to or greater than one. For example, when the buffer status of the sub-system 2 is good, the control signal 202 allows for a larger first number. The first number of the macroblocks can form at least one macroblock, slice, macroblock row, and picture of the multimedia content 204. For example, if the first number is “1”, the macroblock remains as one macroblock; if the first number is “5”, the five macroblocks form one macroblock row, and so on. The counter 205 is configured to count the number of the macroblocks having been decoded by the decoder 203 to generate a counting signal 206 indicating the counting result of the counter 205. In an embodiment of the invention, when the number of the decoded macroblocks reaches the first number; that is the decoder 203 completes decoding of the first number of marcoblocks, the decoder 203 pauses or stops decoding operation in response to the counting signal 206. In other embodiments, the decoding operation of the decoder 203 is paused or stopped in resonse to the counting signal 206 which indicates the number of decoded macroblocks reach a predetermined value which is less than or equal to the first number.

By the aforementioned arrangement, the sub-system 2 is able to decode multimedia content into different numbers of macroblocks depending on the buffer status and the bandwidth status thereof. That is, when the buffer and/or bandwidth statuses are good, the sub-system 2 is able to decode one picture at a time. If the buffer and/or bandwidth statuses are not that good, the sub-system 2 decodes one slice at a time. If the buffer and/or bandwidth statuses are extremely band, the sub-system 2 decodes a macroblock at a time. The sub-system 2 decodes the multimedia content in a flexible fashion.

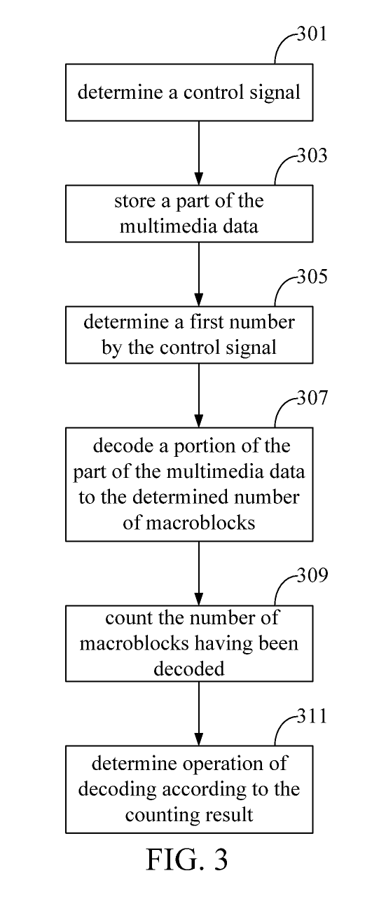

FIG. 3 shows a flow chart for decoding a multimedia content according to a control signal. The multimedia content is the same as the one mentioned above. First, step 301 is executed to determine the control signal. The control signal is determined manually or according to a buffer status and/or a bandwidth status. The buffer status and bandwidth status are as mentioned above. In step 303, a part of the multimedia content is stored, wherein the part of the multimedia content comprises at least one encoded macroblock. Proceeding to step 305, a first number is determined by the control signal. In some other embodiments, step 305 may be omitted, that is, the first number is automatically determined once the control signal is determined. In step 307, a part of the multimedia content is decoded to the first number of macroblocks. The first number of macroblocks forms at least one of a macroblock, a slice, a macroblock row, and a picture of the multimedia content. In step 309, the number of macroblocks having been decoded is counted. Followed by step 311, the operation of decoding is determined according to the counting result. To be more specific, in step 311 the decoding operation is stopped or paused when the number of decoded macroblocks is equal to the first number.

The executing sequence of the aforementioned steps is not a limitation of the present invention. For example, the step 303 can be executed before step 301. In addition, step 311 can be executed any time before decoding or before any step has been executed. People skilled in the art can easily modify the executing sequences after reading and understanding the descriptions of the present invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for decoding multimedia content according to a control signal, comprising:
a memory for storing a part of the multimedia content comprising at least one encoded macroblock; and
a decoder for decoding a portion of the part of the multimedia content to a number of macroblocks, the number being determined by the control signal.

2. The apparatus of claim 1, wherein the determined number of the macroblocks forms at least one of a macroblock, a slice, a macroblock row, and a picture of the multimedia content.

3. The apparatus of claim 1, further comprising:
a counter for counting the number of the macroblocks having been decoded by the decoder;
wherein the decoder controls the decoding operation according to the counting result.

4. The apparatus of claim 3, wherein the decoder stop decoding operation when the number of decoded marcoblocks equals the number determined by the control signal.

5. The apparatus of claim 1, wherein the control signal is determined manually or is determined according to any of a buffer status and a bandwidth status of the apparatus.

6. The apparatus of claim 1, wherein the multimedia content is Joint Photographic Experts Group (JPEG) or Moving Picture Experts Group (MPEG) bitstreams.

7. A method for decoding a multimedia content according to a control signal, comprising the steps of:
storing a part of the multimedia content comprising at least one encoded macroblock; and
decoding a portion of the part of the multimedia content to a number of macroblocks, the number being determined by the control signal.

8. The method of claim 7, wherein the determined number of the macroblocks forms at least one of a macroblock, a slice, a macroblock row, and a picture of the multimedia content.

9. The method of claim 7, further comprising:
counting the number of the macroblocks having been decoded;
wherein the decoding step is controlled according to the counting result.

10. The method of claim 9, wherein the decoding step stops decoding operation when the number of decoded marcoblocks equals the number determined by the control signal.

11. The method of claim 7, wherein the control signal is determined manually or is determined according to one of a buffer status and a bandwidth status.

12. The method of claim 7, wherein the multimedia content is Joint Photographic Experts Group (JPEG) or Moving Picture Experts Group (MPEG) bitstreams.

13. An apparatus for decoding a multimedia content according to a control signal, comprising:
storing means for storing a part of the multimedia content comprising at least one encoded macroblock; and
decoding means for decoding a portion of the part of the multimedia content to a number of macroblocks, the number being determined by the control signal.

14. The apparatus of claim 13, wherein the determined number of the macroblocks forms at least one of a macroblock, a slice, a macroblock row, and a picture of the multimedia content.

15. The apparatus of claim 13, further comprising:
counting means for counting the number of macroblocks having been decoded by the decoding means;
wherein the decoding means controls the decoding operation according to the counting result.

16. The apparatus of claim 15, wherein the decoding means stops operation when the number of decoded macroblocks equals the number determined by the control signal.

17. The apparatus of claim 13, wherein the control signal is determined manually or is determined according to one of a buffer status and a bandwidth status.

18. The apparatus of claim 13, wherein the multimedia content is Joint Photographic Experts Group (JPEG) or Moving Picture Experts Group (MPEG) bitstreams.

19. A multimedia system, comprising:
a receiver for receiving a multimedia content and a control signal; and
an apparatus for decoding the multimedia content according to the control signal, comprising:
a memory for storing a part of the multimedia content comprising at least one encoded macroblock; and
a decoder for decoding a portion of the part of the multimedia content to a number of macroblocks, the number being determined by the control signal.

20. A television, comprising:
a receiver for receiving a multimedia content and a control signal; and
an apparatus for decoding the multimedia content according to the control signal, comprising:
a memory for storing a part of the multimedia content comprising at least one encoded macroblock; and
a decoder for decoding a portion of the part of the multimedia content to a number of macroblocks, the number being determined by the control signal.

21. A portable multimedia playback system, comprising:
a receiver for receiving a multimedia content and a control signal; and
an apparatus for decoding the multimedia content according to the control signal, comprising:
a memory for storing a part of the multimedia content comprising at least one encoded macroblock; and
a decoder for decoding a portion of the first part of the multimedia content to a number of macroblocks, the number being determined by the control signal.

22. A DVD system, comprising:
a receiver for receiving a multimedia content and a control signal; and
an apparatus for decoding the multimedia content according to the control signal, comprising:
a memory for storing a part of the multimedia content comprising at least one encoded macroblock; and
a decoder for decoding a portion of the part of the multimedia content to a number of macroblocks, the number being determined by the control signal.
